(19) United States
(12) Patent Application Publication
(10) Pub. No.: US 2007/0072074 A1
(43) Pub. Date: Mar. 29, 2007

(54) Non-aqueous electrolyte secondary battery

(76) Inventors: Hidekazu Yamamoto, Kobe-shi (JP); Keiji Saisho, Kobe-shi (JP)

Correspondence Address: KUBOVCIK & KUBOVCIK, SUITE 710, 900 17TH STREET NW, WASHINGTON, DC, 20006, US

(21) Appl. No.: 11/527,608

(22) Filed: Sep. 27, 2006

(30) Foreign Application Priority Data
Sep. 28, 2005 (JP) 2005-281957
Aug. 23, 2006 (JP) 2006-226679

(51) Int. Cl. H01M 10/40; H01M 4/58

(52) U.S. Cl. 429/200; 429/338; 429/218.1; 429/330

(57) ABSTRACT

A non-aqueous electrolyte secondary battery using silicon as negative electrode active material and containing fluoroethylene carbonate in a non-aqueous electrolyte is provided that minimizes gas generation during storage in a charged state and improves charge-discharge cycle performance. The non-aqueous electrolyte secondary battery is provided with a negative electrode containing silicon as a negative electrode active material, a positive electrode, and a non-aqueous electrolyte containing electrolyte salts and a solvent. The non-aqueous electrolyte contains fluoroethylene carbonate, and the electrolyte salts include LiBF₄ and another electrolyte salt that is less consumed relative to LiBF₄ during charge-discharge cycling.

### BACKGROUND OF THE INVENTION

1. Field of the Invention

The present invention relates to non-aqueous electrolyte secondary batteries, and more particularly to a non-aqueous electrolyte secondary battery in which silicon is contained as a negative electrode active material and fluoroethylene carbonate is contained in the non-aqueous electrolyte.

2. Description of Related Art

Significant size and weight reductions in mobile electronic devices such as mobile telephones, notebook computers, and PDAs have been achieved in recent years. In addition, power consumption of such devices has been increasing as the number of functions of the devices has increased. As a consequence, demand has been increasing for lighter weight and higher capacity lithium secondary batteries used as power sources for such devices.

Currently, carbon materials such as graphite are commonly used for negative electrodes of lithium secondary batteries. The capacity that is possible with graphite materials, however, has already reached the limit determined by the theoretical capacity (372 mAh/g), and the graphite materials no longer meet the demand for further higher battery capacity.

In order to fulfill the foregoing demand, alloy-based negative electrodes made of such materials as silicon, germanium, and tin have been proposed in recent years as materials that show higher charge-discharge capacities per unit mass and per unit volume than carbon-based negative electrodes. In particular, silicon is considered as a good candidate for a negative electrode material since silicon shows a high theoretical capacity of about 4000 mAh per 1 g of active material.

When silicon is used as a negative electrode active material, the active material expands and shrinks due to charge and discharge. Especially when silicon expands due to a charge reaction, the newly exposed surface is reactive and therefore causes a side reaction with the electrolyte solution, degrading the charge-discharge cycle performance of the battery.

In order to minimize the side reaction, it has been proposed to add an addition agent such as vinylene carbonate (VC), vinyl ethylene carbonate (VEC), and fluoroethylene carbonate (FEC) to the electrolyte solution. (See, for example, Published PCT Application WO 2002/058182.)

Allowing the addition agents as described above to be present in the electrolyte solution makes it possible to form a surface film on the surface of the negative electrode and thereby minimize the side reaction between silicon and the electrolyte solution. In particular, fluoroethylene carbonate is considered to be a promising addition agent since it significantly contributes to an improvement in the cycle performance of the battery employing an alloy-based negative electrode.

A problem with the use of these addition agents, however, has been that decomposition occurs at the positive electrode side and gas generation occurs when the battery is stored at a high temperature in a charged state. This is because an alloy-based negative electrode shows a higher potential than a graphite negative electrode, and therefore the positive electrode is brought to a higher potential if the battery is charged to the same voltage level. The gas generation causes increases in the thickness and internal resistance of the battery and is therefore problematic in actual use of the battery.

### BRIEF SUMMARY OF THE INVENTION

Accordingly, it is an object of the present invention to provide a non-aqueous electrolyte secondary battery in which silicon is used as the negative electrode active material and fluoroethylene carbonate is contained in the non-aqueous electrolyte solution, and in which gas generation during storage in a charged state is minimized and also good charge-discharge cycle performance is exhibited.

In order to accomplish the foregoing and other objects, the present invention provides a non-aqueous electrolyte secondary battery comprising a negative electrode containing silicon as a negative electrode active material; a positive electrode; and a non-aqueous electrolyte containing electrolyte salts and a solvent, wherein the non-aqueous electrolyte contains fluoroethylene carbonate, and the electrolyte salts include LiBF₄ and another electrolyte salt that is less consumed relative to the LiBF₄ during charge-discharge cycling.

According to the present invention, gas generation during storage in a charged state can be minimized and moreover battery charge-discharge cycle performance can be improved in a non-aqueous electrolyte secondary battery that uses silicon as a negative electrode active material and contains fluoroethylene carbonate in the non-aqueous electrolyte.

### DETAILED DESCRIPTION OF THE INVENTION

According to the present invention, the non-aqueous electrolyte contains fluoroethylene carbonate. Therefore, deterioration of negative electrode active material can be minimized, and the charge-discharge cycle performance can be improved. Moreover, in the battery of the present invention, LiBF₄ is contained as an electrolyte salt. Therefore, the gas generation originating from decomposition of fluoroethylene carbonate can be minimized. It is believed that, although the details of the mechanism are not yet clear, the reason why the use of LiBF₄ can minimize the gas generation originating from decomposition of fluoroethylene carbonate is as follows.

It is believed that, judging from the structure, fluoroethylene carbonate loses its fluorine at the silicon negative electrode side and decomposes into a compound having a similar structure to vinylene carbonate. On the other hand, it has been known that vinylene carbonate decomposes and generates a gas at the positive electrode side, which is at a high potential. Accordingly, because a decomposed product having a similar structure to vinylene carbonate is produced from fluoroethylene carbonate, decomposition takes place at the positive electrode side at a high potential of 4.3 V (vs. Li/Li⁺) or higher in a similar way to the case of vinylene carbonate, and thus gas generation occurs.

When LiBF₄ is contained in the non-aqueous electrolyte as an electrolyte salt, LiBF₄ first reacts with the surface of the silicon negative electrode, forming a surface film containing fluorine on the surface of the silicon negative electrode. The formation of such a surface film serves to suppress the reaction between fluoroethylene carbonate (FEC) and the silicon negative electrode, minimizing the decomposition of the fluoroethylene carbonate. As a consequence, a decomposed product similar to vinylene carbonate, which is the cause of gas generation, is not formed, and thus, gas generation is prevented.

In the battery according to the present invention, an electrolyte salt that is consumed in a lower amount than LiBF₄ during charge-discharge cycling is further contained as an electrolyte salt. Examples of the electrolyte salt other than LiBF₄ include LiPF₆, LiN(SO₂C₂F₅)₂, and LiN(SO₂CF₃)₂. As will be discussed later, LiBF₄ is consumed in a large amount during charge-discharge cycling, and therefore, in order to compensate for the consumption of LiBF₄, an electrolyte salt other than LiBF₄ is added. The addition of the electrolyte salt other than LiBF₄ prevents a shortage of electrolyte salt, making it possible to enhance the charge-discharge cycle performance of the battery.

It is preferable that the content of LiBF₄ in the non-aqueous electrolyte is within a range of from 0.1 mol/L to 2.0 mol/L. If the content is less than 0.1 mol/L, it may not be possible to obtain the advantageous effects of the present invention that the gas generation during storage in a charged state can be minimized and at the same time the charge-discharge cycle performance can be enhanced. On the other hand, if the content exceeds 2.0 mol/L, the viscosity of the non-aqueous electrolyte increases, making it difficult to sufficiently impregnate the electrode with the non-aqueous electrolyte. This may lead to poor battery performance. It is more preferable that the content of LiBF₄ be within a range of from 0.1 mol/L to 1.5 mol/L, still more preferably within a range of from 0.1 mol/L to 1.0 mol/L, and yet more preferably within a range of from 0.5 mol/L to 1.0 mol/L. It should be noted that the contents of LiBF₄ specified here should be understood to be contents as determined at the time of assembling the battery.

In the present invention, the content of the electrolyte salt other than LiBF₄ is preferably within a range of from 0.1 mol/L to 1.5 mol/L. If the content is less than 0.1 mol/L, the electrolyte salt may be short of what is required for compensating the LiBF₄ that is consumed as the charge-discharge cycles are repeated and the ion conductivity of the non-aqueous electrolyte may be insufficient. This may lead to degradation in battery performance. On the other hand, if the content exceeds 1.5 mol/L, the viscosity of the non-aqueous electrolyte increases, making it difficult to sufficiently impregnate the electrolyte into the electrode. This may also lead to poor battery performance. More preferably, the content is within a range of from 0.1 mol/L to 1.0 mol/L. It should be noted that the contents of the electrolyte salt other than LiBF₄ specified here should be understood to be the contents as determined at the time of assembling the battery.

It is preferable that the mixture ratio of LiBF₄ to the other electrolyte salt upon assembling of the battery be within a range of from 1:20 to 20:1 (LiBF₄:electrolyte salt other than LiBF₄) by weight. If the relative amount of LiBF₄ is too large, ion conductivity degrades as the charge-discharge cycling proceeds, which may degrade battery performance. On the other hand, if the relative proportion of the electrolyte salt other than LiBF₄ is too large, the effects of minimizing gas generation during storage in a charged state and improving charge-discharge cycle performance may not be sufficiently obtained because the content of LiBF₄ becomes relatively small.

In the present invention, it is preferable that the content of fluoroethylene carbonate (FEC) is within a range of from 0.1 weight % to 30 weight % with respect to the total weight of the solvent in the non-aqueous electrolyte. If the content of the fluoroethylene carbonate is too small, the effect of improving the charge-discharge cycle performance may not be sufficiently obtained. On the other hand, too large a content of fluoroethylene carbonate is uneconomical because the effect of improving the charge-discharge cycle performance will not become proportionately greater with the content of fluoroethylene carbonate. It is more preferable that the content of fluoroethylene carbonate be within a range of 1 weight % to 10 weight %, and still more preferably 2 weight % to 10 weight %.

In the present invention, the solvent for the non-aqueous electrolyte other than the fluoroethylene carbonate may be any non-aqueous solvent that is commonly used for non-aqueous electrolyte secondary batteries. Examples include cyclic carbonates, chain carbonates, lactone compounds (cyclic carboxylic ester), chain carboxylic esters, cyclic ethers, chain ethers, and sulfur-containing organic solvents. Preferable examples among these are cyclic carbonates, chain carbonates, lactone compounds (cyclic carboxylic ester), chain carboxylic esters, cyclic ethers, and chain ethers that have a total number of carbon atoms of 3 to 9. It is particularly preferable that a cyclic carbonate and a chain carbonate that have a total number of carbon atoms of 3 to 9 be used either alone or in combination.

The negative electrode in the present invention is a negative electrode employing a negative electrode active material containing silicon. Such a negative electrode may be formed by depositing a thin film containing silicon, such as an amorphous silicon thin film and a non-crystalline silicon thin film, on a negative electrode current collector made of a metal foil such as a copper foil by CVD, sputtering, evaporation, thermal spraying, or plating. The thin film containing silicon may be an alloy thin film of silicon with cobalt, iron, zirconium, and so forth. The method for fabricating such a negative electrode is disclosed in detail in Published PCT Application WO 2004/109839, for example, which is incorporated herein by reference.

In the above-described negative electrode, it is preferable that the thin film is divided by gaps that form along its thickness to form columnar structures, and bottom portions of the columnar structures are in close contact with the negative electrode current collector. By employing such an electrode structure, spaces form around the columnar structures, and these spaces serve to absorb the change in volume due to the expansion and shrinkage of the active material, alleviating the stress associated with charge-discharge cycling. Therefore, good charge-discharge cycle performance is attained. The gaps that form along the film thickness are generally formed by charge-discharge reactions.

The negative electrode in the present invention may be formed from active material particles containing silicon. The negative electrode may be formed by applying a slurry containing the active material particles and a binder onto a current collector. Examples of the active material particles include silicon particles and silicon alloy particles.

The positive electrode active material that may be used in the present invention is not particularly limited as long as it can be used for non-aqueous electrolyte batteries. Examples include lithium transition metal oxides, such as lithium cobalt oxide, lithium manganese oxide, and lithium nickel oxide. These oxides may be used either alone or in combination.

The positive electrode in the present invention generally shows a potential within a range of from 4.3 V to 4.5 V versus Li/Li⁺ in a charged state.

Hereinbelow, the present invention is described in further detail based on examples thereof. It should be construed, however, that the present invention is not limited to the following examples but various changes and modifications are possible without departing from the scope of the invention.

### EXAMPLE 1 AND COMPARATIVE EXAMPLES 1 TO 5

Preparation of Negative Electrode

Both sides of an electrolytic copper foil having a thickness of 18 μm and a surface roughness Ra of 0.188 μm were irradiated with an Ar ion beam at an ion current density of 0.27 mA/cm² at a pressure of 0.05 Pa. Thereafter, the chamber was evacuated to 1×10⁻³ Pa or less, and using single crystal silicon as the evaporation source material, thin films were formed on both sides of the electrolytic copper foil by electron beam evaporation according to the following conditions: Substrate temperature: Room temperature (not heated); Input power: 3.5 kW. The resultant was used as a negative electrode.

A cross-sectional SEM analysis of the current collector on which the thin films were deposited was conducted to measure the film thickness. Consequently, it was found that the thin films were deposited to a thickness of about 7 μm on both sides of the current collector. The thin films were analyzed by a measurement using Raman spectroscopy. A peak in the vicinity of a wavelength of 480 cm⁻¹ was detected, but no peaks were detected around 520 cm⁻¹. This confirmed that the deposited thin films were amorphous thin films.

Preparation of Positive Electrode

Lithium cobalt oxide as a positive electrode active material, Ketjen Black as a conductive agent, and fluororesin as a binder agent were mixed together at a weight ratio of 90:5:5, and the resultant mixture was dissolved in N-methyl-2-pyrrolidone (NMP) to prepare a paste.

The resultant paste was applied uniformly onto both sides of an aluminum foil having a thickness of 20 μm by doctor blading. Next, in a heated dryer, the resultant material was annealed in a vacuum at 100° C. to 150° C. to remove the NMP, and thereafter pressure-rolled with a roll presser so that the thickness became 0.16 mm. Thus, a positive electrode was prepared.

Preparation of Electrolyte Solution

LiBF₄ and/or LiPF₆ as electrolyte salt(s) was/were dissolved into a mixed solvent of 3:7 volume ratio of ethylene carbonate (EC) and diethyl carbonate (DEC) so that their contents were as set forth in Table 1 below. Thereafter, fluoroethylene carbonate (FEC) or vinylene carbonate (VC) was added so that their amounts added were as set forth in Table 1. Thus, electrolyte solutions were prepared.

Preparation of Lithium Secondary Battery

The positive electrode and the negative electrode prepared in the above-described manner were cut out into predetermined dimensions, and current collector tabs were attached to the metal foils, serving as current collectors. A 20-μm thick separator made of a polyolefin-based microporous film was interposed between the electrodes to form a laminate, and this was coiled. The outermost circumference was fastened with an adhesive tape to form an electrode assembly, and thereafter the electrode assembly was pressed into a flat shape, to thus form a spirally-wound electrode assembly.

The spirally-wound electrode assembly was inserted into a battery case made of a laminated material in which PET (polyethylene terephthalate) and aluminum were layered, and the current collector tabs were made to protrude outwardly through an opening.

Next, 2 mL of the above-described electrolyte solution were filled into the battery case through the opening of the battery case, and thereafter the opening was sealed. Thus, a lithium secondary battery was fabricated. The battery thus fabricated had a discharge capacity of 250 mAh.

Charge-discharge Cycle Test

Batteries of Example 1 and Comparative Examples 1 to 5, each of which was fabricated in the above-described manner, were charged at a charge current of 250 mA until the battery voltage-reached 4.2 V, thereafter further charged at a constant voltage of 4.2 V until the current value reached 13 mA, and thereafter discharged at a current of 250 mA until the battery voltage became 2.75 V, to complete one charge-discharge cycle. This charge-discharge cycle was repeated 100 times. The percentage of the discharge capacity at the 100th cycle to the discharge capacity at the first cycle was determined as capacity retention ratio (%). The results are shown in Table 1 below.

Measurement of Battery Thickness Increase after Storage in Charged State

Before being subjected to the cycle test, the batteries were stored in a charged state under high temperature. Specifically, they were stored at 60° C. for 15 days, and the battery thickness increase was measured for each of the batteries. The results are also shown in Table 1 below.

TABLE 1

| | | | | | | Battery thickness |
|---|---|---|---|---|---|---|
| | Amount | Amount | | | Discharge capacity | increase after |
| | of VC | of FEC | LiPF₆ | LiBF₄ | retention ratio | storage in a |
| | added | added | content | content | after 100 cycles | charged state |
| | (wt. %) | (wt. %) | (mol/L) | (mol/L) | (%) | (mm) |
| Comp. Ex 1 | — | — | 1.0 | — | 50.8 | 0.101 |
| Comp. Ex 2 | 2 | — | 1.0 | — | 70.7 | 1.096 |
| Comp. Ex 3 | — | 2 | 1.0 | — | 72.8 | 1.228 |
| Comp. Ex 4 | — | — | 0.5 | 0.5 | 68.3 | 0.125 |
| Comp. Ex 5 | 2 | — | 0.5 | 0.5 | 79.3 | 1.264 |
| Ex. 1 | — | 2 | 0.5 | 0.5 | 75.2 | 0.115 |

Table 1 shows that, as seen from Comparative Examples 1 to 3, which use LiPF₆ alone as the electrolyte salt, the addition of either VC or FEC improves the charge-discharge cycle performance but, on the other hand, increases the battery thickness considerably due to gas generation.

Likewise, when both LiBF₄ and LiPF₆ are used and VC is added, gas generation occurs and the battery thickness increases, as in the cases of using LiPF₆ alone, although the charge-discharge cycle performance is improved. In contrast, when FEC is added according to the present invention, the charge-discharge cycle performance is improved, and at the same time the gas generation is minimized, so that the battery thickness increase is lessened.

Vinylene carbonate decomposes and generates a gas at the positive electrode side. It is believed that, on the other hand, fluoroethylene carbonate loses its fluorine at the silicon negative electrode side and decomposes into a compound having a similar structure to vinylene carbonate, and the decomposed product generates a gas at the positive electrode side.

At this time, if LiBF₄ is contained in the electrolyte solution, the LiBF₄ will first decompose at the surface of the silicon negative electrode, forming a surface film containing fluorine on the surface of the silicon negative electrode. It is believed that this surface film inhibits the decomposition of fluoroethylene carbonate at the silicon negative electrode, and as a result, a decomposed product similar to vinylene carbonate does not form, and thereby gas generation during storage in a charged state is minimized. Accordingly, it is believed that even when LiBF₄ is contained in an electrolyte solution containing vinylene carbonate, gas generation during storage in a charged state cannot be prevented.

Thus, according to the present invention, when fluoroethylene carbonate is contained in the non-aqueous electrolyte and LiBF₄ and LiPF₆ are contained as the electrolyte salts, it becomes possible to minimize the gas generation during storage in a charged state and at the same time improve the charge-discharge cycle performance. This is believed to be due to the decomposition of LiBF₄ which takes place instead of the decomposition of fluoroethylene carbonate. Therefore, this advantageous effect can be verified if a decrease in the amount of LiBF₄ in the electrolyte solution is confirmed.

Confirmation of Consumption of LiBF₄

LiBF₄ and LiPF₆ as electrolyte salts were dissolved into a mixed solvent of 3:7 volume ratio of ethylene carbonate (EC) and diethyl carbonate (DEC) so that their concentration would be 0.5 mol/L. A lithium secondary battery was prepared in the same manner as in Example 1 above, except that the just-described electrolyte solution was used.

A charge-discharge cycle test was conducted until the capacity retention ratio reached 30% under the same conditions as set out above, and the contents of LiBF₄ were measured before the charge-discharge cycles and after the charge-discharge cycles.

The electrolyte solution inside the battery infiltrates the interior of the separator and the electrodes, so the electrolyte solution cannot be taken out merely by opening the battery in a normal way. For this reason, a portion of the laminate battery case was opened, then 1 mL of DEC was poured through the opening, and after setting the battery aside for 10 minutes, the electrolyte solution to which the DEC was added was taken out. The taken-out electrolyte solution was analyzed by ion chromatography to determine the concentrations of the electrolyte salts in the electrolyte solution. The results of the measurement are shown in Table 2 below. The values shown as relative ratio in Table 2 are values standardized by taking the concentration of LiPF₆ as 100%.

TABLE 2

| | LiPF₆ | LiBF₄ |
|---|---|---|
| Amount added upon assembling (absolute value) | 0.5 M | 0.5 M |
| Amount added upon assembling (relative value) | 100% | 100% |
| Before cycling (relative ratio) | 100% | 96% |
| After cycling (relative ratio) | 100% | 1.9% |

As clearly seen from Table 2, the concentrations of LiPF₆ and LiBF₄ added at the time of assembling of the battery were almost the same at the initial stage, but the proportion of LiBF₄ significantly lowered after the cycling, which dropped to less than 1/50 of the proportion of LiPF₆. This demonstrates that LiBF₄ is consumed in charge-discharge cycling.

### EXAMPLES 2 TO 8

Batteries of Examples 2 to 8 were prepared in the same manner as in Example 1 above, except that the amounts of fluoroethylene carbonate (FEC) added and the contents of LiBF₄ and LiPF₆ were as set forth in Table 3. The discharge capacity retention ratio after 100 cycles and the battery thickness increase after storage in a charged state were determined for each of the batteries in the same manner as in Example 1 above. The results are shown in Table 3 below. Table 3 also shows the results for Example 1 and Comparative Examples 1 to 5 for comparison.

TABLE 3

| | | | | | | Battery thickness |
|---|---|---|---|---|---|---|
| | Amount | Amount | | | Discharge capacity | increase after |
| | of VC | of FEC | LiPF₆ | LiBF₄ | retention ratio | storage in a |
| | added | added | content | content | after 100 cycles | charged state |
| | (wt. %) | (wt. %) | (mol/L) | (mol/L) | (%) | (mm) |
| Comp. Ex 1 | — | — | 1.0 | — | 50.8 | 0.101 |
| Comp. Ex 2 | 2 | — | 1.0 | — | 70.7 | 1.096 |
| Comp. Ex 3 | — | 2 | 1.0 | — | 72.8 | 1.228 |
| Comp. Ex 4 | — | — | 0.5 | 0.5 | 68.3 | 0.125 |
| Comp. Ex 5 | 2 | — | 0.5 | 0.5 | 79.3 | 1.264 |
| Ex. 1 | — | 2 | 0.5 | 0.5 | 75.2 | 0.115 |
| Ex. 2 | — | 5 | 0.5 | 0.5 | 75.8 | 0.116 |
| Ex. 3 | — | 10 | 0.5 | 0.5 | 79.1 | 0.410 |
| Ex. 4 | — | 10 | 0.5 | 1.0 | 78.5 | 0.130 |
| Ex. 5 | — | 10 | 0.5 | 1.5 | 72.1 | 0.051 |
| Ex. 6 | — | 30 | 0.5 | 0.5 | 81.7 | 0.942 |
| Ex. 7 | — | 30 | 0.5 | 1.0 | 78.8 | 0.510 |
| Ex. 8 | — | 30 | 0.5 | 2.0 | 75.1 | 0.213 |

As clearly seen from the results shown in Table 3, the discharge capacity retention ratio after 100 cycles increases and the charge-discharge cycle performance thus improves when the amount of added fluoroethylene carbonate (FEC) is greater. However, the amount of gas generated during storage in a charged state also increases, and the battery thickness tends to increase correspondingly after storage in a charged state.

It will be appreciated that such battery thickness increase can be minimized by increasing the content of LiBF₄, as seen in Table 3. Nevertheless, increasing the content of LiBF₄ in turn tends to degrade the charge-discharge cycle performance.

The results shown in Table 3 clearly demonstrate that, in order to achieve both desirable storage performance in a charged state and good charge-discharge cycle performance, it is preferable that the amount of added FEC be within a range of from 2 weight % to 10 weight %, and at the same time, the content of LiBF₄ be within a range of from 0.1 mol/L to 1.0 mol/L

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

This application claims priority of Japanese patent application Nos. 2005-281957 and 2006-226679 filed Sep. 28, 2005, and Aug. 23, 2006, respectively, which are incorporated herein by reference.

What is claimed is:

1. A non-aqueous electrolyte secondary battery comprising:
a negative electrode containing silicon as a negative electrode active material;
a positive electrode; and
a non-aqueous electrolyte containing electrolyte salts and a solvent, wherein
the non-aqueous electrolyte contains fluoroethylene carbonate, and the electrolyte salts include LiBF₄ and another electrolyte salt that is less consumed relative to the LiBF₄ during charge-discharge cycling.

2. The non-aqueous electrolyte secondary battery according to claim 1, wherein the content of the LiBF₄ in the non-aqueous electrolyte is within a range of from 0.1 mol/L to 2.0 mol/L.

3. The non-aqueous electrolyte secondary battery according to claim 1, wherein the electrolyte salt other than the LiBF₄ is at least one substance selected from the group consisting of LiPF₆, LiN(SO₂C₂F₅)₂, and LiN(SO₂CF₃)₂.

4. The non-aqueous electrolyte secondary battery according to claim 2, wherein the electrolyte salt other than the LiBF₄ is at least one substance selected from the group consisting of LiPF₆, LiN(SO₂C₂F₅)₂, and LiN(SO₂CF₃)₂.

5. The non-aqueous electrolyte secondary battery according to claim 1, wherein the negative electrode active material is composed of a thin film containing silicon and is deposited on a current collector by sputtering or by vacuum evaporation.

6. The non-aqueous electrolyte secondary battery according to claim 2, wherein the negative electrode active material is composed of a thin film containing silicon and is deposited on a current collector by sputtering or by vacuum evaporation.

7. The non-aqueous electrolyte secondary battery according to claim 3, wherein the negative electrode active material is composed of a thin film containing silicon and is deposited on a current collector by sputtering or by vacuum evaporation.

8. The non-aqueous electrolyte secondary battery according to claim 4, wherein the negative electrode active material is composed of a thin film containing silicon and is deposited on a current collector by sputtering or by vacuum evaporation.

9. The non-aqueous electrolyte secondary battery according to claim 1, wherein the content of fluoroethylene carbonate is within a range of from 0.1 weight % to 30 weight % with respect to the total weight of the solvent of the non-aqueous electrolyte.

10. The non-aqueous electrolyte secondary battery according to claim 2, wherein the content of fluoroethylene carbonate is within a range of from 0.1 weight % to 30 weight % with respect to the total weight of the solvent of the non-aqueous electrolyte.

11. The non-aqueous electrolyte secondary battery according to claim 3, wherein the content of fluoroethylene carbonate is within a range of from 0.1 weight % to 30 weight % with respect to the total weight of the solvent of the non-aqueous electrolyte.

12. The non-aqueous electrolyte secondary battery according to claim 4, wherein the content of fluoroethylene carbonate is within a range of from 0.1 weight % to 30 weight % with respect to the total weight of the solvent of the non-aqueous electrolyte.

13. The non-aqueous electrolyte secondary battery according to claim 1, wherein the positive electrode shows a potential within a range of from 4.3 V to 4.5V versus Li/Li⁺ in a charged state.

14. The non-aqueous electrolyte secondary battery according to claim 2, wherein the positive electrode shows a potential within a range of from 4.3 V to 4.5V versus Li/Li⁺ in a charged state.

15. The non-aqueous electrolyte secondary battery according to claim 3, wherein the positive electrode shows a potential within a range of from 4.3 V to 4.5V versus Li/Li⁺ in a charged state.

16. The non-aqueous electrolyte secondary battery according to claim 9, wherein the positive electrode shows a potential within a range of from 4.3 V to 4.5V versus Li/Li⁺ in a charged state.

17. The non-aqueous electrolyte secondary battery according to claim 1, wherein the content of fluoroethylene carbonate is within a range of from 2 weight % to 10 weight % with respect to the total weight of the solvent of the non-aqueous electrolyte, and the content of the LiBF₄ is within a range of from 0.1 mol/L to 1.0 mol/L.

18. The non-aqueous electrolyte secondary battery according to claim 2, wherein the content of fluoroethylene carbonate is within a range of from 2 weight % to 10 weight % with respect to the total weight of the solvent of the non-aqueous electrolyte, and the content of the LiBF₄ is within a range of from 0.1 mol/L to 1.0 mol/L.

19. The non-aqueous electrolyte secondary battery according to claim 10, wherein the content of fluoroethylene carbonate is within a range of from 2 weight % to 10 weight % with respect to the total weight of the solvent of the non-aqueous electrolyte, and the content of the LiBF₄ is within a range of from 0.1 mol/L to 1.0 mol/L.

20. The non-aqueous electrolyte secondary battery according to claim 11, wherein the content of fluoroethylene carbonate is within a range of from 2 weight % to 10 weight % with respect to the total weight of the solvent of the non-aqueous electrolyte, and the content of the LiBF₄ is within a range of from 0.1 mol/L to 1.0 mol/L.
